(19) United States
(12) Patent Application Publication
(10) Pub. No.: US 2010/0156750 A1
(43) Pub. Date: Jun. 24, 2010

(54) Feeding Structure of Housing With Antenna

(76) Inventors: Tatsuo Ishibashi, Kyoto-shi (JP); Shuzo Okumura, Kyoto-shi (JP)

Correspondence Address: Wenderoht Lind & Ponack, 2033 K Street N W, Suite 800, Washington, DC, 20006, US

(21) Appl. No.: 12/223,989

(22) PCT Filed: Feb. 19, 2007
(86) PCT No.: PCT/JP2007/052944

§ 371 Date: Aug. 14, 2008

(30) Foreign Application Priority Data
Feb. 19, 2006 (JP) 2006-041730
Feb. 19, 2006 (JP) 2006/041731

(51) Int. Cl. H01Q 1/40

(52) U.S. Cl. 343/873; 343/872

(57) ABSTRACT

A feeding structure of a housing with an antenna, in which a flat antenna can be attached inconspicuously to the outer surface of the housing which is hard to be affected by a metal component and power can be supplied to the flat antenna without providing a through hole causing inferior appearance. The feeding structure of the housing with an antenna comprises a housing 2, a decorative film 3 covering at least a part of the outer wall face of the housing 2, a flat antenna 6 held between the outer wall face of the housing 2 and the decorative film 3, and an electrode 7 provided on the inner wall face of the housing 2. In the feeding structure, a capacitor is formed by arranging a feeding part 6a of the flat antenna 6 and the electrode 7 opposite to each other in both faces of the housing 2 and power transmission and communication are performed in a noncontact manner for the flat antenna 6 on the outside of the housing 2 from the inside of the housing 2 by connecting an inductor 8 with the electrode 7.

### TECHNICAL FIELD

The present invention relates to a feeding structure of a housing with an antenna for transmitting power and signals to an antenna installed using the outer face of a housing of a compact mobile appliance such as a mobile phone, a PDA (Personal Digital Assistance), an MP3 (MPEG-1 Audio Layer 3: international standard for compression of audio information) player, and the like.

### BACKGROUND ART

An antenna is required to provide a communication function to compact mobile appliances such as a PDA and an MP3 player as well as a mobile phone and, for example, Japanese Patent Application Laid-Open (JP-A) No. 2001-136255 proposes a mobile phone, in which such a kind of antenna is built in the inside of a housing of a mobile appliance.

However, there are a metal shield case and a ground plane (a flat body made of a conductor for reflecting electromagnetic wave) for eliminating effects due to radiation of unnecessary electromagnetic wave in the inside of the housing and the existence of these metal components considerably deteriorates the communication function of the antenna.

In order to reduce the effects of such a metal component on the antenna, there is no way but the metal component have to be kept far from the antenna and consequently, proposed is a configuration for attaching the antenna to the housing at a position most outside of a mobile appliance to integrate the antenna with the housing.

In the case where the housing and the antenna are integrated, a configuration (a), in which a flat antenna is stuck to the outer wall face of a housing, or a configuration (b), a flat antenna is stuck to the inner wall face of a housing can be supposed.

In the above-mentioned configuration (a), since impacts from the outside of the mobile appliance tend to be applied, the flat antenna is possibly damaged and it is disadvantageous in terms of design that existence of the flat antenna is conspicuous.

Further, as shown in FIG. 17, in the case where a flat antenna 51 is stuck to the outer wall face of a housing 50, it is needed to connect a power feeding part 51a of the flat antenna 51 and an oscillation circuit (not shown) in the inside of the housing 50 and thus a through hole 52 for leading a lead wire has to be provided in the housing 50.

If the through hole 52 is provided, since the power feeding part 51a in a portion where the through hole 52 is formed does not have a supporting body, the flat antenna 51 is partially deformed to result in defective appearance. A reference numeral 53 in the figure shows a film substrate in which the flat antenna 51 is formed.

On the other hand, in the above-mentioned configuration (b), since reinforcing ribs exist in an uneven state in the inner wall face of the housing, there occurs a problem that the size and shape of an antenna pattern are limited when the antenna pattern is designed. Further, the flat antenna is set closer to the metal components corresponding to at least the thickness of the housing and tends to be affected.

### DISCLOSURE OF THE INVENTION

In consideration of the above-mentioned problems of a conventional antenna for a compact mobile appliance, the present invention is accomplished. An object of the present invention is to provide a feeding structure of a housing with an antenna, in which a flat antenna can be attached inconspicuously to the outer surface of the housing which is hard to be affected by a metal component and power can be supplied to the flat antenna without providing a through hole causing defective appearance.

According to a first aspect of the present invention, a feeding structure of a housing with an antenna comprises a housing, a decorative film covering at least a part of the outer wall face of the housing, a flat antenna held between the outer wall face of the housing and the decorative film, and an electrode provided on the inner wall face of the housing, in which a capacitor is formed by arranging a feeding part of the flat antenna and the electrode opposite to each other in both faces of the housing and transmission of power and a signal are performed in a noncontact manner for the flat antenna by connecting an inductor generating an electromagnetic field to the electrode.

In the present invention, power transmission and signal transmission are generically named as feeding.

Further, in the present invention, the housing includes those which compose a portion of an exterior part.

The above-mentioned housing may be formed by resin molding and also made of glass, a ceramic, or the like.

The above-mentioned decorative film may be a laminated film having a decorative layer capable of concealing the flat antenna on at least one side of a transparent resin film, or a monolayer film containing a coloring agent capable of concealing the flat antenna in the transparent resin film.

The thickness of the housing sandwiched between the feeding part and the electrode is preferably 1 mm or less. In this case, the inductance of the inductors may be 1 mH or less.

If the electrode is provided in a recessed part formed in the inner wall face of the housing, the housing can be made thin and have improved strength without changing the capacitance.

Further, if the flat antenna and the housing are integrated by insert molding, the outer surface of the housing can be made flat and smooth.

According to a second aspect of the present invention, a feeding structure of a housing with an antenna comprises a housing, a decorative film covering at least a part of the outer wall face of the housing, and a flat antenna held between the outer wall face of the housing and the decorative film, in which the flat antenna is a spiral antenna formed as a conductive layer on a film substrate and transmission of power and a signal are performed in a noncontact manner for the flat antenna by using the spiral antenna as a closed circuit and arranging an inductor in the periphery of the spiral antenna.

An antenna pattern of the spiral antenna may be formed only in one face of the film substrate and also in both faces of the film substrate.

In the case where an antenna pattern is formed in each of the respective faces of the above-mentioned film substrate, if an electrode is provided in each of the antenna patterns and the electrodes are arranged opposite to each other with the film substrate interposed therebetween, the film substrate may form a sheet of a capacitor.

Further, the spiral patterns formed in the respective faces of the film substrate can be connected with each other through a through hole penetrating the film substrate.

Furthermore, in the case where each of the spiral patterns formed in the respective faces of the film substrate has one end and the other end, the electrodes formed in one ends are arranged opposite to each other with the film substrate interposed therebetween to form a capacitor and the other ends are connected directly with each other through a through hole provided in the film substrate.

In the second aspect, the flat antenna and the housing are preferably integrated by insert molding.

According to the feeding structure of the housing with an antenna, the flat antenna can be attached inconspicuously to the outer surface of the housing.

Further, since feeding to the flat antenna can be carried out in a noncontact manner, it is no need to provide a through hole for feeding in the housing. Accordingly, defective appearance due to the through hole for feeding, such as deformation and swollenness of the decorative film and the antenna film can be solved.

### BRIEF DESCRIPTION OF THE DRAWINGS

FIG. 1 is a vertical cross-sectional view of a main portion showing a first embodiment of a feeding structure of a housing with an antenna according to the present invention.

FIG. 2 is a plane view showing an antenna pattern of the flat antenna shown in FIG. 1.

FIG. 3 is an equivalent view of FIG. 2 showing a second antenna pattern of the flat antenna.

FIG. 4 is an equivalent circuit schematic of a feeding structure of a housing with an antenna of the present invention.

FIG. 5 is an equivalent view of FIG. 1 showing another embodiment of an electrode installation structure.

FIG. 6 is a vertical cross-sectional view showing a laminated state of a decorative film and an antenna film.

FIG. 7 is an equivalent view of FIG. 6 showing another laminated state of a decorative film and an antenna film.

FIG. 8 is a vertical cross-sectional view of a main part showing a second embodiment of a feeding structure of a housing with an antenna according to the present invention.

FIG. 9 is a perspective view showing a third antenna pattern.

FIG. 10 is an equivalent circuit schematic of a feeding structure of a housing with an antenna shown in FIG. 8.

FIG. 11 is a perspective view showing a fourth antenna pattern.

FIG. 12 is a perspective view showing a fifth antenna pattern.

FIG. 13 is a perspective view showing a sixth antenna pattern.

FIG. 14 is a perspective view showing a seventh antenna pattern.

FIG. 15 is a vertical cross-sectional view of a main portion showing a first arrangement of an inductor.

FIG. 16 is an equivalent view of FIG. 15 showing a second arrangement of an inductor.

FIG. 17 is a vertical cross-sectional view of a main portion showing a conventional configuration of a housing with an antenna.

### BEST MODE FOR CARRYING OUT THE INVENTION

Hereinafter, embodiments of the present invention will be described in detail with reference to drawings.

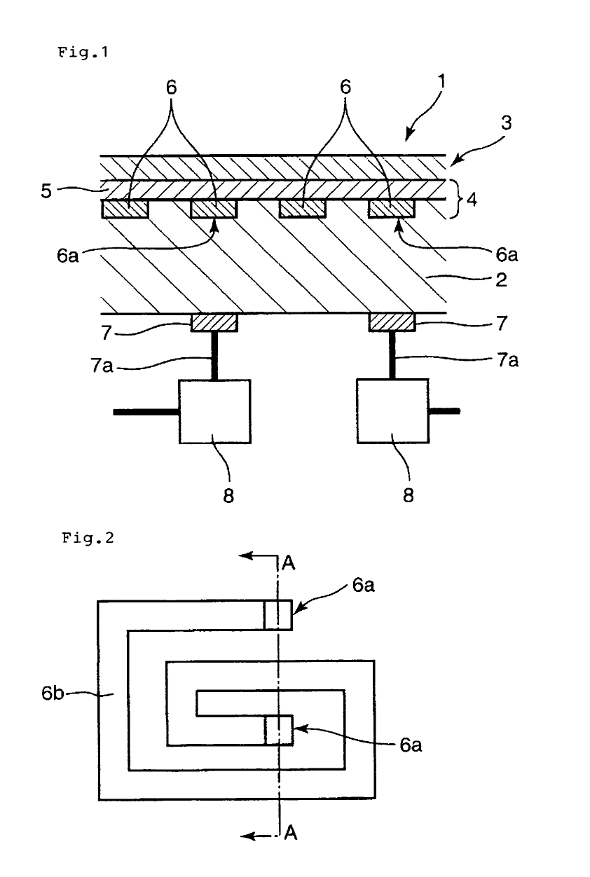

FIG. 1 is a vertical cross-sectional view of a feeding structure of a housing with an antenna according to the present invention in the case where the feeding structure is applied for a mobile phone as a compact mobile appliance.

In the same figure, a housing 1 with an antenna constitutes a laminated body including a housing 2 formed by resin molding, a decorative film 3 covering the outer wall face of the housing 2, and an antenna film 4 sandwiched between the housing 2 and the decorative film 3.

The antenna film 4 is formed by patterning a film substrate 5 made of a resin film with a flat antenna 6 which is a conductive layer.

An electrode 7 is formed in the inner wall face of the housing 2 opposite to a feeding part 6a, which is a portion of the flat antenna 6. The housing 2 in combination with the feeding part 6a and the electrode 7 which are arranged at a distance in both sides of the housing, that is, kept in a noncontact state, can be regarded as a sheet of a capacitor.

Each of the respective electrodes 7 is connected in series to a chip type inductor 8 to form an LC resonance circuit.

Next, the respective layers forming the housing 1 with an antenna will be specifically described.

### 1. Housing

The housing 2 is formed by molding into a desired outer shape using a die. The material may be selected depending on the uses of appliances and molding methods, and may be selected from a methacrylic resin (PMMA), an acrylonitrile-styrene copolymer resin (AS), an acrylonitrile-butadiene-styrene copolymer resin (ABS), a cellulose propionate resin, a polycarbonate resin (PC), a polystyrene resin (PS), a polyester resin, and a polyethylene resin.

### 2. Decorative Film

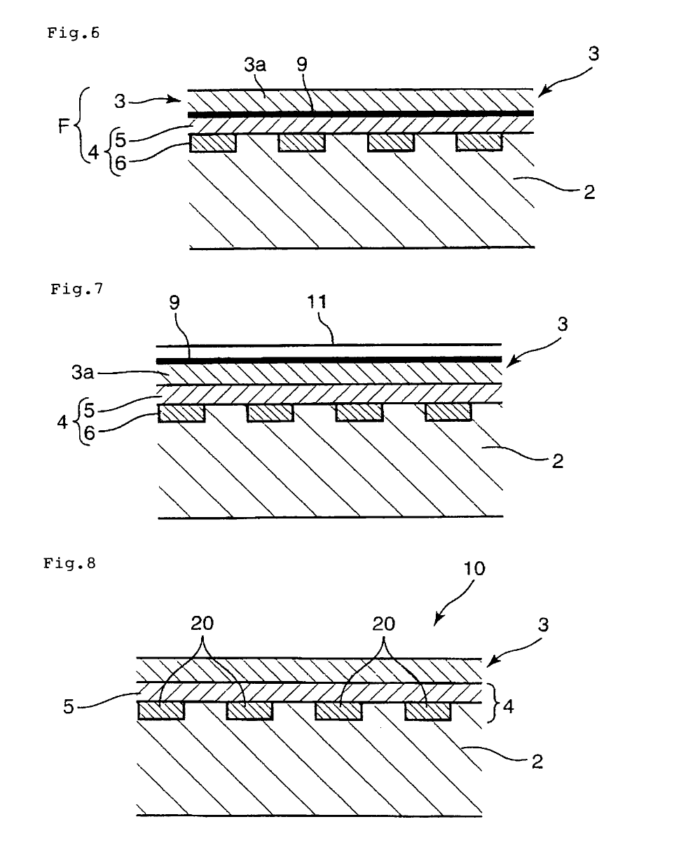

The decorative film 3 is for decorating the housing 2 and a film obtained by forming a decorative layer (see a reference numeral 9 of FIG. 6 or 7) on at least one face of a transparent resin film is generally used.

Examples of a material of the above-mentioned transparent resin film may include, for example, a polycarbonate-based, polyamide-based and polyether ketone-based engineering plastic and an acrylic, polyethylene terephthalate-based, and polybutylene terephthalate-based resin film.

### 2.1 Decorative Layer

The decorative layer 9 may be generally, a colored ink layer and colored ink containing a urethane resin, a PC resin, a vinyl resin, or a polyester resin can be used. In particular, colored ink containing a urethane-based resin, or further its elastomer as a binder, and a pigment or a dye with a proper color as a coloring agent is preferably used.

Further, examples of a method for forming the above-mentioned colored ink layer may include a printing method such as an offset printing method, a gravure printing method, and a screen printing method, and a coating method such as a gravure coating method, a roll coating method, and a comma coating method.

The entire outer wall face of the housing 2 may be decorated with the decorative layer 9 of the decorative film 3 or a portion of the outer wall face of the housing 2 may not be decorated to leave a transparent window part using a transparent resin film as it is.

Further, in the case where the entire outer wall face of the housing 2 is not decorated with the decorative layer 9, in place of formation of the decorative layer 9 by forming the colored ink layer, a pigment or a dye with a proper color may be added as a coloring agent to a transparent resin film to form the decorative layer 9.

Furthermore, the decorative layer 9 may be formed on both faces of the transparent resin film, and if the layer is formed in a housing 2 side in a laminated state, fingers or the like does not directly contact with the decorative layer and it is thus advantageous that the decorative layer 9 can be protected from wear.

### 3. Antenna Film

The film substrate 5 of the antenna film 4 is not particularly limited as far as it is a material which has a function as a supporting material for the flat antenna 6 and examples to be used may be, similarly to those of the transparent resin film which is the substrate of the decorative film 3, a polycarbonate-based, polyamide-based and polyether ketone-based engineering plastic and an acrylic, polyethylene terephthalate-based, and polybutylene terephthalate-based resin film.

The conductive layer forming the flat antenna 6 is not particularly limited as far as it is formed of a conductive substance which may be provided with an antenna function. Examples of materials having conductivity include, for example, as a metal, gold, platinum, silver, copper, aluminum, nickel, zinc, lead, and the like. Further, a polymer compound having conductivity, such as a conductive polymer may be selected as the conductive layer. Furthermore, the configuration of the conductive layer of a metal and a polymer compound having conductivity may be a foil, printing, plating, and the like.

### 3.1 Flat Antenna

The antenna patterns of the flat antenna 6 may be properly selected depending on a frequency band to be employed and uses and may be various antenna patterns to be used for wireless LAN, Bluetooth, RFID (Radio Frequency Identification), GPS (Global Positioning System), ETC (Electronic Toll Collection System), communication, and the like.

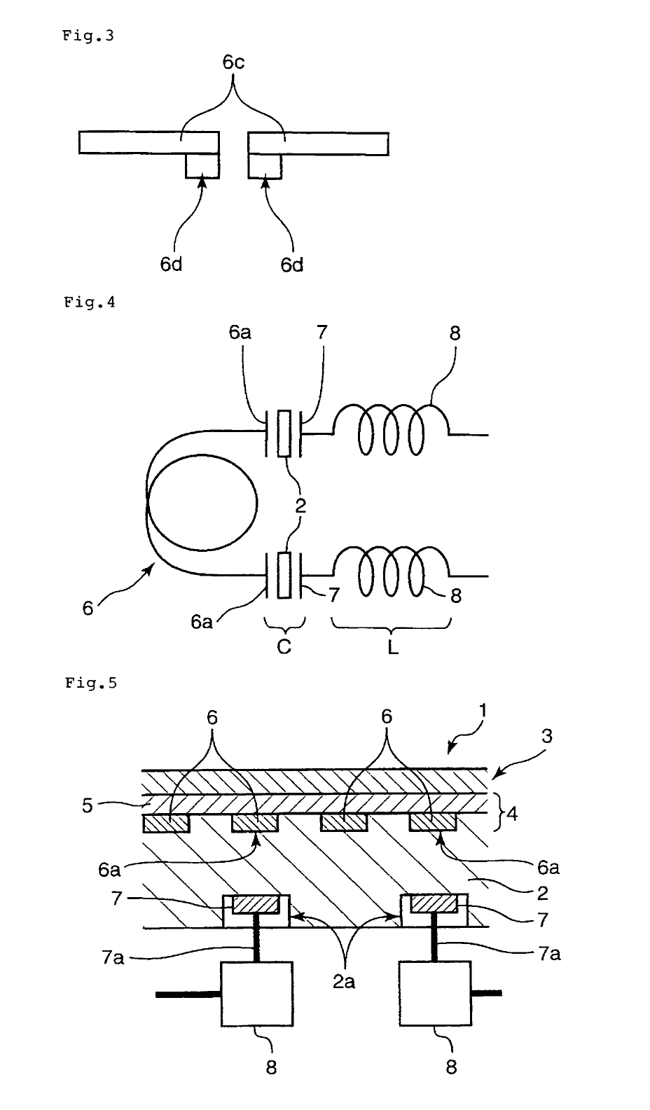

Specific examples of the antenna patterns may include a spiral antenna 6b shown in FIG. 2 as a first antenna pattern, a dipole antenna 6c shown in the plane view of FIG. 3 as a second antenna pattern, and the like. Here, a reference numeral 6d in FIG. 3 shows a feeding part.

The cross-sectional view cut along an A-A arrow line in the spiral antenna 6b shown in FIG. 2 is the vertical cross-sectional view of FIG. 1.

Patterning of the flat antenna 6 can be carried out by a screen printing method in the case where the conductive layer is formed using a paste, and a common method such as an etching method using printing resist or photosensitive resist may be employed in the case where the conductive layer is of a foil or formed by plating.

### 4. Equivalent Circuit

FIG. 4 shows an equivalent circuit schematic in which the housing 2 sandwiched between the feeding part 6a of the flat antenna 6 (spiral antenna 6b in the figure) and the electrode 7 works as a dielectric part of a capacitor C and is coupled with an inductor L(8) to work as a resonance circuit.

The capacitance of the capacitor C including the feeding part 6a, the housing 2, and the electrode 7 can be adjusted by changing the dielectric constant and the thickness of the housing 2 and the surface area of the feeding part 6a and the electrode 7.

The above-mentioned capacitance and proper inductance are selected and adjusted so as to cause series resonance at an aimed frequency. The thickness of the housing 2 forming the capacitor C is preferably adjusted to be 1 mm or less and in this case, the inductance of the inductor 8 is preferably adjusted to be 1 mH or less.

A material and a formation method of the conductive layer forming the electrode 7 may be the same as the material and the formation method of the flat antenna 6, however a method of sticking a conductive tape cut in several square mm to the inner surface of the housing 2 is the simplest formation method.

In the case where the housing 1 with an antenna is required to have high strength, the thickness of the housing 2 has to be made thick, and in such a case, a recessed part 2a for installation of the electrode 7 may be formed in the inner wall face of the housing 2 as shown in FIG. 5. Accordingly, the thickness of the housing 2 at a portion where the capacitor C is formed can be kept 1 mm or less.

The recessed parts 2a may be formed using a tool after molding of the housing 2 or formed during molding of the housing 2.

The inductor 8 is proper to be mounted in the inside of the housing 2 and, for example, a common chip inductor or the like can be used. Further, the inductor may be mounted in the inner wall face of the housing 2 together with the electrode 7. Detail will be described later.

The housing 1 with an antenna may be produced by an insert molding method to make the outer surface of the housing smooth.

5. Method for Producing Housing with Antenna

Next, an insert molding method for sandwiching the antenna film 4 between the housing 2 and the decorative film 3 and integrating them will be described.

At first, in FIG. 6, the antenna film 4 is stuck to and laminated on one face of the decorative film 3 (in the case where the decorative layer 9 is formed only in one face of a transparent resin film 3a to be the base of the decorative film 3, the face where the decorative layer 9 is formed is preferable) with a transparent adhesive to obtain an insert film F.

In the case where the flat antenna 6 of the antenna film 4 is opaque, the decorative film 3 and the antenna film 4 are stuck to each other in a manner that the flat antenna 6 can be concealed with the decorative layer 9 of the decorative film 3.

Next, the insert film F is set and heated in a die for molding and preliminarily molded so as to follow the shape of the molding surface of the die.

Then, the preliminarily molded insert film F is sent to be a molding die including a movable die and a fixed die. At that time, sheets of the insert film F may be fed one by one or molded parts of a long and continuous insert film F may be intermittently fed.

Subsequently, after the molding die is closed, the cavity is filled with a melted resin injected through a gate formed in the fixed die and the housing 2 is formed and simultaneously the insert film F is stuck to the face in the side that becomes an outer wall face.

After the molded housing 2 is cooled and solidified, the molding die is opened to take out the housing 2 and if necessary, unneeded portions of the insert film F in the periphery of the housing are removed to complete the housing 1 with an antenna.

Hereinbefore, a representative method for producing the housing 1 with an antenna is described, however methods for producing the housing 1 with an antenna should not be limited to the method. For example, in place of the insert molding, after the housing 2 is formed by molding and the insert film F may be stuck to the surface.

Further, a hard coat treatment may be carried out for the outermost side of the housing 1 with an antenna.

As shown in FIG. 7, in the case where a hard coat layer 11 is formed in the housing 1 with an antenna, even if the decorative layer 9 of the decorative film 3 is formed in the outside of the transparent resin film 3a, the decorative layer 9 can be protected by the existence of the hard coat layer 11 from wear by contact with fingers or the like. Examples of the hard coat treatment method may include a method of applying a hard coat material such as an acrylic resin, a silicon resin, and a UV-curable resin, a method of sticking a hard coat film, and the like.

Further, in the housing 1 with an antenna of the present invention, in order to carry out feeding in a noncontact manner between the feeding part 6a and electrode 7, the flat antenna 6 of the antenna film 4 may be provided in the face of the film substrate 5 in the housing 2 side or in the face of the film substrate 5 in the decorative film 3 side. Furthermore, it may be formed in both sides of the film substrate 5. In this case, the conduction of the flat antennas 6 formed in both sides of the film substrate 5 may be performed by a common conduction method via a through hole penetrating the film substrate 5 (for example, via a copper platting formed in the through hole 5a).

Further, with respect to the antenna film 4, in the case where the flat antenna 6 is formed in the housing side face of the film substrate 5, the flat antenna 6 on the housing 2 side may be coated with a cover layer of an adhesive or a resin film. If the flat antenna 6 is coated with the cover layer in such a manner, the flat antenna 6 is protected from the melted resin fluidized in the insert molding.

6. Second Embodiment of Feeding Structure of Housing with an Antenna According to the Present Invention

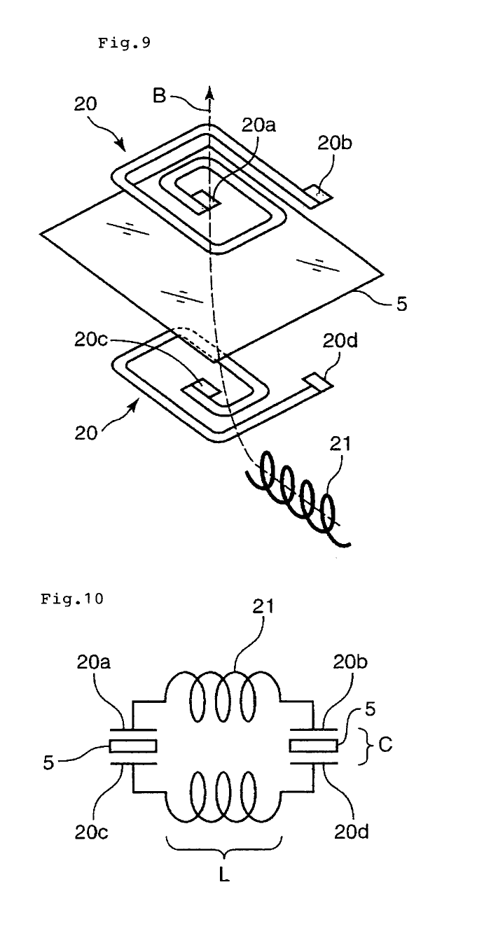

FIG. 8 shows a vertical cross-sectional view of a housing with an antenna in the case where a closed circuit type spiral antenna is used as a flat antenna. The same constituent elements as those of FIG. 1 will be denoted by the respective same reference numerals and their explanations are omitted in the following description.

In FIG. 8, a housing 10 with an antenna comprises a housing 2, and a decorative film 3 covering at least a portion of the outer wall face of the housing 2 and a spiral antenna 20 having a closed circuit is sandwiched between the decorative film 3 and the housing 2. This spiral antenna 20 has a conductive layer on a film substrate 5 as an antenna pattern.

FIGS. 9 to 14 show specific examples of the above-mentioned antenna pattern.

For explanation convenience in the respective drawings, the antenna pattern is shown in a state that it is parted from the film substrate, however actually, the antenna pattern is brought into contact with the film substrate.

The antenna pattern shown in FIG. 9 is formed by forming the spiral antennas 20 in both sides of the film substrate 5 (the third antenna pattern) and making them into a closed circuit. Both spiral antennas 20 are wound in the same direction and accordingly the number of turns is increased.

In the configuration shown in the same figure, electromagnetic coupling is performed in an inductor 21 arranged in an induction magnetic field B, so that power and signal transmission can be carried out in a noncontact manner.

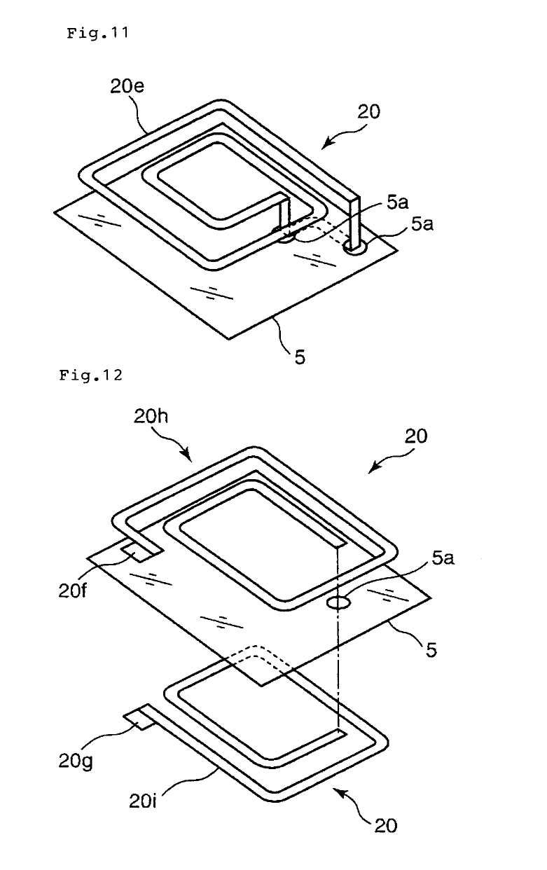

FIG. 10 shows an equivalent circuit in which the film substrate 5 sandwiched between feeding part 20a (or 20b) of the spiral antennas 20 and the electrode 21a (or 21b) shown in FIG. 9 functions as a dielectric part of the capacitor C and is coupled with the inductor L (21) to work as an LC resonance circuit.

The antenna pattern shown in FIG. 11 is formed by forming a spiral pattern 20e (the fourth antenna pattern) of the spiral antenna 20 only on one face of the film substrate 5 and connecting both ends of the spiral antenna 20 via a through hole 5a penetrating the film substrate 5. The conduction through the through hole 5a may be performed by, for example, copper plating formed in the through hole 5a. In place of the through hole 5a, means such as a jumper or the like may be used to connect both ends described above.

The antenna patterns shown in FIG. 12 are spiral patterns 20h and 20i (the fifth antenna patterns) formed by combining a feeding part 20f for a capacitor and an electrode 20g with the through hole 5a and according to the antenna patterns, the spiral antennas 20 in both faces of the film substrate 5 can be composed to be a closed circuit and therefore, the electromagnetic coupling can be strengthened.

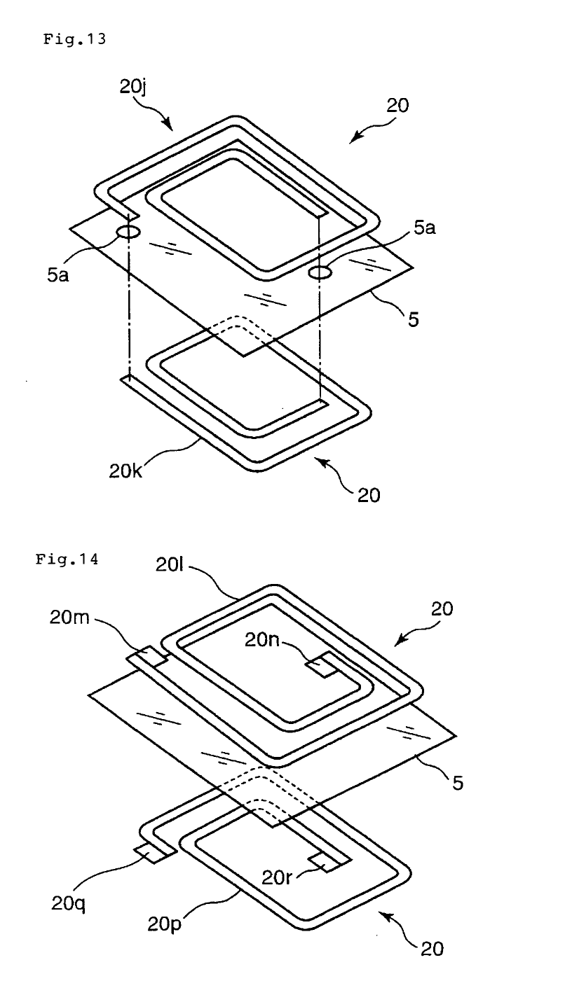

With respect to the antenna patterns shown in FIG. 13, spiral patterns 20j and 20k (the sixth antenna patterns) are connected via through holes 5a and 5a to form the spiral antennas 20 in both faces of the film substrate 5 and the spiral antennas 20 in both faces can be formed so as to be a closed circuit and therefore, the electromagnetic coupling can be strengthened as compared with that of the antenna pattern shown in FIG. 12.

With respect to the antenna patterns shown in FIG. 14, electrodes 20m and 20n are formed in both ends of a spiral pattern 201 arranged in one face of the film substrate 5 and also electrodes 20q and 20r are formed in both ends of a spiral pattern 20p arranged in the other face of the film substrate 5 and the electrode 20m and the electrode 20q are arranged opposite to each other and at the same time the electrode 20n and the electrode 20r are arranged opposite to each other to form the spiral patterns 20 in both faces of the film substrate 5 (seventh antenna patterns).

According to the antenna patterns, the electrode 20m and the electrode 20q can form a capacitor and the electrode 20n and the electrode 20r can form a capacitor, respectively and thus a closed circuit is formed in both faces of the film substrate 5 without forming a through hole to cause electromagnetic coupling.

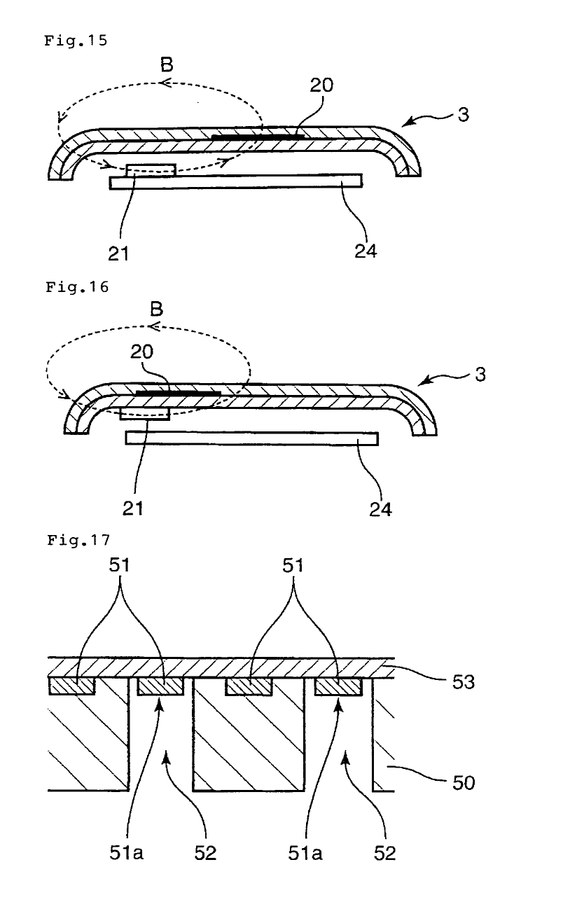

In the respective antenna patterns of FIGS. 9 to 14, the inductor 21 may be installed at an arbitrary position at which the inductor 21 can share the induction magnetic field B and for example, as shown in FIG. 15, the inductor 21 can be mounted on the top face of the substrate 24 in the housing 2 and the inner wall face of the housing 2 as shown in FIG. 16.

Hereinafter, the present invention will be described more in detail with reference to Examples; however it is not intended that the present invention be limited to the following Examples. Modifications and substitutions to specific process conditions and structures can be made without departing from the spirit and scope of the present invention.

### EXAMPLES

### Example 1

At first, a 50 μm-thick PET film was used as a film substrate 5 and as a conductive layer, a 18 μm-thick copper foil was formed in one face and successively the copper foil was patterned in a spiral antenna shape for RFID by a photo etching method to form a flat antenna 6 and obtain an antenna film 4 (reference to FIG. 1).

Further, a decorative layer was formed in one face of a 50 μm-thick transparent acrylic film by a gravure printing method to obtain a decorative film 3.

Next, the antenna film 4 was stuck to a decorative layer side of the decorative film 3 by a transparent adhesive to obtain an insert film which was preliminarily molded so as to follow a shape of a molding die for forming the outer shape of a housing 2.

Herein, in the case where the decorative film 3 and the antenna film 4 were stuck to each other, the flat antenna 6, the films substrate 5, the decorative layer, and the transparent acrylic film were laminated in this order.

Next, using a molding die capable of molding a 1 mm-thick housing 2, after the insert film was inserted in the molding die (in the state that the flat antenna 6 is opposite to the cavity space) and the die was closed, an acrylic resin was injected into the cavity to obtain a housing 1 with an antenna.

After cooling and solidifying of the injected resin, the housing 1 with an antenna was taken out from the die and the unneeded parts of the insert film in the periphery of the housing were removed to complete the housing 1 with an antenna.

In the housing 1 with an antenna produced in the above-mentioned manner, a conductive tape of a 5 mm-square size was stuck to a portion in the inner wall face corresponding to the feeding part 6a of the flat antenna 6 to form an electrode 7 and then an inductor 8 was connected to the electrode 7 with a lead wire 7a to form an LC circuit.

When feeding was carried out to the flat antenna 6 by generating series resonance at 13.56 MHz with a capacitance of 0.7 pF and an inductance of 200 μH, it was confirmed that transmission and reception of signals were made possible between the spiral antenna and a communication counterpart prepared separately in the vicinity.

### Example 2

At first, a 50 μm-thick PET film was used as a film substrate 5 and as a conductive layer, a 18 μm-thick copper foil was formed in one face and successively the copper foil was patterned in a spiral antenna shape by a printing method to form a flat antenna 6 and obtain an antenna film 4 (reference to FIG. 5).

Further, a decorative layer was formed in one face of a 50 μm-thick transparent polycarbonate film by a gravure printing method to obtain a decorative film 3.

Next, the antenna film 4 was stuck to a decorative layer side of the decorative film 3 by a transparent adhesive to obtain an insert film which was preliminarily molded so as to follow a shape of a molding die for forming the outer shape of a housing 2. The sticking of the decorative film 3 and the antenna film 4 was carried out in the same manner as in Example 1.

Next, using a molding die capable of molding a 1 mm thick housing 2, after the insert film was inserted in the molding die and the die was closed, an ABS resin was injected into the cavity to obtain a housing 1 with an antenna.

After cooling and solidifying of the injected resin, the housing 1 with an antenna was taken out from the die and the unneeded parts of the insert film in the periphery of the housing were removed to complete the housing 1 with an antenna.

In the housing 1 with an antenna produced in the above-mentioned manner, recessed parts 2a with a depth of 0.5 mm were formed in portions in the inner wall face corresponding to the feeding parts 6a of the flat antenna 6 and conductive tapes of 4 mm square size were stuck to the recessed parts 2a to form electrodes 7 and then inductors 8 were connected to the electrodes 7 with lead wires 7a to form an LC circuit.

When feeding was carried out to the flat antenna 6 by generating series resonance at 13.56 MHz with a capacitance of 0.9 pF and an inductance of 160 μH, it was confirmed that transmission and reception of signals were made possible between the spiral antenna and a communication counterpart prepared separately in the vicinity.

### Example 3

At first, a 25 μm-thick polyimide film was used as a film substrate 5 and as a conductive layer, a 18 μm-thick copper foil was formed in one face and successively the copper foil was patterned in a spiral antenna shape by an etching method using printing resist to form a flat antenna 6 and obtain an antenna film 4 (reference to FIG. 5).

Further, a decorative layer was formed in one face of a 50 μm-thick transparent acrylic film by a gravure printing method to obtain a decorative film 3.

Next, the antenna film 4 was stuck to a decorative layer side of the decorative film 3 by a transparent adhesive to obtain an insert film which was preliminarily molded to have a shape along a molding die for forming the outer shape of a housing 2.

Next, using a molding die capable of molding a 1 mm thick housing, after the insert film was inserted in the molding die and the die was closed, a polycarbonate resin was injected into the cavity to obtain a housing with an antenna.

After cooling and solidifying of the injected resin, the housing with an antenna was taken out from the die and the unneeded parts of the insert film in the periphery of the housing were removed to complete the housing with an antenna.

In the housing 1 with an antenna produced in the above-mentioned manner, recessed parts with a depth of 0.3 mm were formed in portions in the inner wall face corresponding to the feeding parts 6a of the flat antenna 6 and conductive tapes of 3 mm square size were stuck to the recessed parts to form electrodes 7 and then inductors 8 were connected to the electrodes 7 with lead wires 7a to form an LC circuit.

When feeding was carried out to the flat antenna 6 by generating series resonance at 13.56 MHz with a capacitance of 0.3 pF and an inductance of 400 μH, it was confirmed that transmission and reception of signals were made possible between the spiral antenna and a communication counterpart prepared separately in the vicinity.

### Example 4

A spiral antenna pattern 20e of 5 cm×7 cm (outside dimension) was formed in a double-sided CCL (Copper Clad Laminate) substrate composed of a 50 μm-thick polyimide film and a 18 μm-thick copper foil to obtain an antenna film (reference to FIG. 11).

After the outline of the antenna film was cut, the film was stuck to a transparent acrylic film in which a design was formed.

Next, after the designed film with the antenna was inserted in the molding die and the die was closed, an ABS resin was injected into the cavity to carry out insert molding and obtain a housing with an antenna.

With respect to the housing with an antenna, feeding was tried to the spiral antenna by arranging an inductor at a position at which the induction magnetic field could be shared to cause electromagnetic coupling. As a result, it was confirmed that transmission and reception of signals were made possible between the spiral antenna and that of a communication counterpart prepared separately in the vicinity.

### Example 5

Spiral antenna patterns of 5 cm×3 cm (outside dimension) were formed in both faces of a double-sided CCL substrate composed of a 25 μm-thick polyimide film and a 18 μm-thick copper foil and the spiral patterns 20j and 20k in front and rear sides were bonded via a through hole 5a to form a closed circuit (reference to FIG. 13).

After the outline of the antenna film was cut, the film was stuck to a polycarbonate film in which a design was formed.

Next, after the designed film with the antenna was inserted in the molding die, an ABS resin was injected to carry out insert molding and obtain a housing with an antenna.

With respect to the housing with an antenna, feeding was tried to the spiral antenna by arranging an inductor at a position at which the induction magnetic field could be shared to cause electromagnetic coupling. As a result, it was confirmed that transmission and reception of signals were made possible between the spiral antennas and those of a communication counterpart prepared separately in the vicinity.

### Example 6

Spiral antenna patterns 20h and 20i of 5 cm×7 cm (outside dimension) having electrodes of 5 mm square size at both ends were formed in both faces of a double-sided CCL substrate composed of a 75 μm-thick PET film and a 12 μm-thick copper foil by an etching method using printing resist in the same winding directions (reference to FIG. 14).

The arrangements of the electrodes in the front and rear sides of the CCL substrate were conformed and accordingly a capacitor is formed to form a closed circuit.

After the spiral antenna film was stuck to an acrylic film in which a design was printed, insert molding was carried out to stick the resulting film to the ABS resin injected into the molding die.

Feeding was tried to the spiral antenna by arranging an inductor at a position at which the induction magnetic field could be shared to cause electromagnetic coupling. As a result, it was confirmed that transmission and reception of signals were made possible between the spiral antennas and those of a communication counterpart prepared separately in the vicinity.

### INDUSTRIAL APPLICABILITY

The present invention can be employed for an outer package for compact mobile appliances such as mobile phones, PDA, MP3 player, and the like and preferable for the case the outer package is provided an antenna function.

1. A feeding structure of a housing with an antenna comprising a housing, a decorative film covering at least a part of the outer wall face of the housing, a flat antenna held between the outer wall face of the housing and the decorative film, and an electrode provided on the inner wall face of the housing, wherein
a capacitor is formed by arranging a feeding part of the flat antenna and the electrode opposite to each other in both faces of the housing and transmission of power and a signal are performed in a noncontact manner for the flat antenna by connecting an inductor to the electrode.

2. The feeding structure of the housing with an antenna according to claim 1, wherein
the decorative film is a laminated film having a decorative layer capable of concealing the flat antenna on at least one side of a transparent resin film, or a monolayer film containing a coloring agent capable of concealing the flat antenna in the transparent resin film.

3. The feeding structure of the housing with an antenna according to claim 1, wherein
the thickness of the housing held between the feeding part and the electrode is 1 mm or less.

4. The feeding structure of the housing with an antenna according to claim 3, wherein
the inductance of the inductor is 1 mH or less.

5. The feeding structure of the housing with an antenna according to claim 1, wherein
the electrode is provided in a recessed part formed in the inner wall face of the housing.

6. The feeding structure of the housing with an antenna according to claim 1, wherein
the flat antenna and the housing are integrated by insert molding.

7-13. (canceled)
